(19) United States
(12) Patent Application Publication
(10) Pub. No.: US 2004/0090544 A1
(43) Pub. Date: May 13, 2004

(54) Image processing apparatus

(75) Inventors: Michihiro Fujiyama, Kyoto (JP); Seiji Hashimoto, Osaka (JP); Aritaka Mizutani, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 10/700,518

(22) Filed: Nov. 5, 2003

(30) Foreign Application Priority Data
Nov. 8, 2002 (JP) 2002-325686

(51) Int. Cl. H04N 5/262

(52) U.S. Cl. 348/231.99

(57) ABSTRACT

An image processing apparatus is applied to a surveillance camera system which includes a hard disk recorder. The hard disk recorder reproduces images intermittently recorded. At a time of reproducing the images, in a case an operation for shortening an image reproducing period of the images is performed, the hard disk recorder immediately renews an image irrespective of an image reproducing period stored in a register so as to renew the image currently displayed to a next image and, at the same time, shortens the image reproducing period stored in the register. Furthermore, in a case an operation for lengthening the image reproducing period is performed, the hard disk recorder lengthens the image reproducing period stored in the register without renewing the image currently displayed.

### BACKGROUND OF THE INVENTION

1. Field of the Invention

The present invention relates to an image processing apparatus applied to a surveillance camera system. More specifically, the present invention relates to an image processing apparatus capable of changing an image reproducing period of images intermittently recorded.

2. Description of the Prior Art

When a hard disk recorder and the like reproduces images intermittently recorded at a predetermined time interval, a user sometimes intends to shorten or lengthen an image reproducing period of the images. In this case, the user can change the image reproducing period stored in a register to a desired image reproducing period by operating front switches of the hard disk recorder.

It is possible to change the image reproducing period stored in the register; however, it is only after the changed image reproducing period lapses that an image currently displayed on a monitor is changed to a next image. Therefore, the user has to wait until the changed image reproducing period lapses and thus, operability of the hard disk recorder is lowered.

### SUMMARY OF THE INVENTION

Therefore, it is a primary object of the present invention to provide a novel image processing apparatus.

Another object of the present invention is to provide an image processing apparatus which is improved in operability.

According to the present invention, an image processing apparatus which sequentially reproduces a plurality of screens of still image signals recorded in a recording medium, comprising: a timer for measuring an image reproducing period; a first reproducer for reproducing one screen of still image signal from the recording medium every time that a time of the timer elapses; a second reproducer for reproducing one screen of still image signal from the recording medium every time that an image renewal instruction is issued; a restarter for restarting the timer every time that the one screen of still image signal is reproduced; a changer for changing the image reproducing period in response to a period changing instruction; and an issuer for issuing the image renewal instruction in response to the period changing instruction.

The image processing apparatus, every time that the time of the timer for measuring the image reproducing period elapses, reproduces one screen of still image signal from the recording medium by the first reproducer. In a case the image renewal instruction is issued before the time of the timer elapses, one screen of still image signal is reproduced from the recording medium by the second reproducer. At a time of reproduction, in a case the period changing instruction is issued, the image reproducing period is changed, and the image renewal instruction is issued. In this case, a change of the period is instructed, the image reproducing period is changed, and the image renewal instruction is also issued so as to renew the image and therefore, operability of the image processing apparatus is improved.

Preferably, when the period changing instruction is for extending the image reproducing period, the image processing apparatus does not issue the image renewal instruction. As a consequence thereof, only in a case of shortening the image reproducing period, the image is renewed in response to the issue of the image renewal instruction, and therefore, the operability of the image processing apparatus is improved.

Preferably, the changing instruction with respect to the image processing apparatus is input according to a direction to which a dial is turned. The issue of the image renewal instruction is stopped when a reproducing direction of the plurality of screens of the image signals is a first reproducing direction and a rotating direction of the dial is a first rotating direction, or when the reproducing direction of the plurality of screens of the image signals is a second reproducing direction and the rotating direction of the dial is the second rotating direction. In this case, whether the issue of the image renewal instruction is stopped or not is determined depending upon the reproducing direction of the still image and the rotating direction of the dial, and therefore, the operability of the image processing apparatus is improved.

Preferably, the first reproducing direction of the plurality of screens of the still image signals is a forward reproducing direction, the second reproducing direction is a reverse reproducing direction, the first rotating direction of the dial is a counterclockwise direction, and the second rotating direction of the dial is a clockwise direction. That is, stopping the issue of the image renewal instruction occurs in a case where the reproducing direction is the forward reproducing direction and the rotating direction of the dial is the counterclockwise direction, or in a case where the reproducing direction is the reverse reproducing direction and the rotating direction of the dial is the clockwise direction.

Preferably, the image processing apparatus can not only reproduce the plurality of screens of the image signals recorded in the recording medium but also record the plurality of screens of the still image signals in the recording medium.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing one embodiment of the present invention;

FIG. 2 is an illustrative view of a front panel of a hard disk recorder provided in FIG. 1 embodiment;

FIG. 3 is an illustrative view showing data format recorded in the hard disk provided in FIG. 1 embodiment;

FIG. 4 is a timing chart of FIG. 1 embodiment;

FIG. 5 is a flowchart showing a part of an operation of FIG. 1 embodiment; and

FIG. 6 is a flowchart showing another part of the operation of FIG. 1 embodiment.

### DETAILED DESCRIPTION OF THE PREFERRED EMBODIMENTS

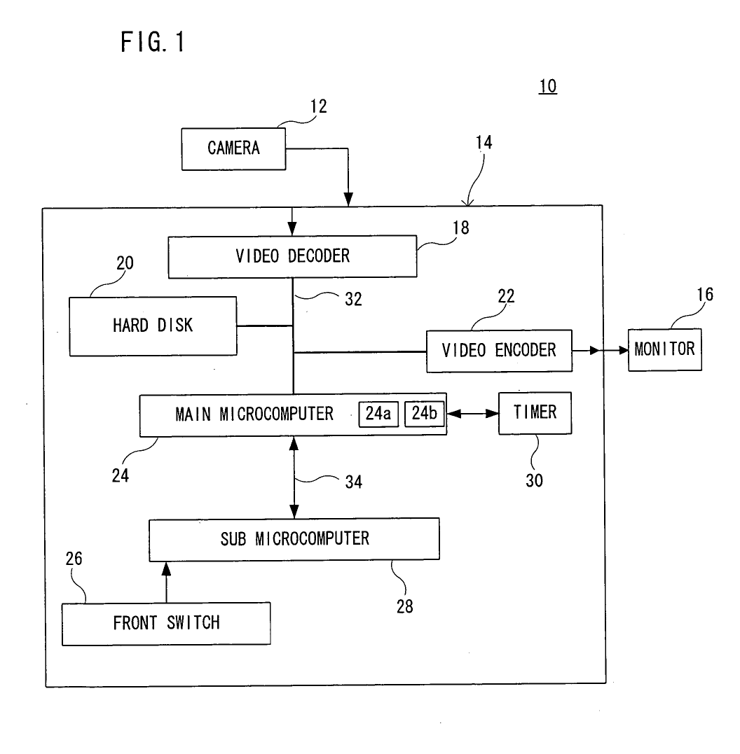

Referring to FIG. 1, a surveillance camera system 10 of this embodiment includes a surveillance camera 12, a hard disk recorder 14 and a monitor 16. The surveillance camera 12 applies an image signal obtained by photographing an object to the hard disk recorder 14.

The image signal applied from the surveillance camera 12 is applied to a video decoder 18 of the hard disk recorder 14. The video decoder 18 converts the applied image signal into image data through an A/D conversion, and then, the image data is compressed by a JPEG format so as to obtain JPEG data. The JPEG data is sequentially recorded in a hard disk 20 via a bus 32. An operation of reproducing the image data recorded in the hard disk 20 is described later.

It is noted that a memory within a main microcomputer 24 is provided with a register 24a for storing an image reproducing period of an image and a register 24b for storing a reproducing direction of the image. Furthermore, the main microcomputer 24 is connected with a timer 30. Therefore, when a value stored in the register 24a is set to the timer 30, the timer 30 counts a time until a lapse of the value.

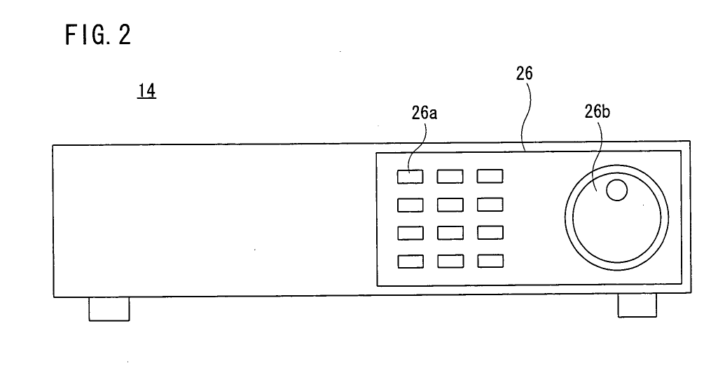

The hard disk recorder 14 further includes front switches 26. The front switches 26 include operating buttons 26a for determining a recording mode and a reproducing direction of the image and a jog dial 26b for changing the image reproducing period of the image. It is noted that the jog dial 26b is a jog shuttle capable of functioning as a shuttle dial by a changing operation. An instruction applied by a user via the front switches 26 is processed in a sub microcomputer 28 and then transmitted to the main microcomputer 24 via a dedicated communication bus 34. It is noted that the front switches 26 such as operating buttons 26a, jog dial 26b and etc. are provided on a front panel of the hard disk recorder 14 as shown in FIG. 2.

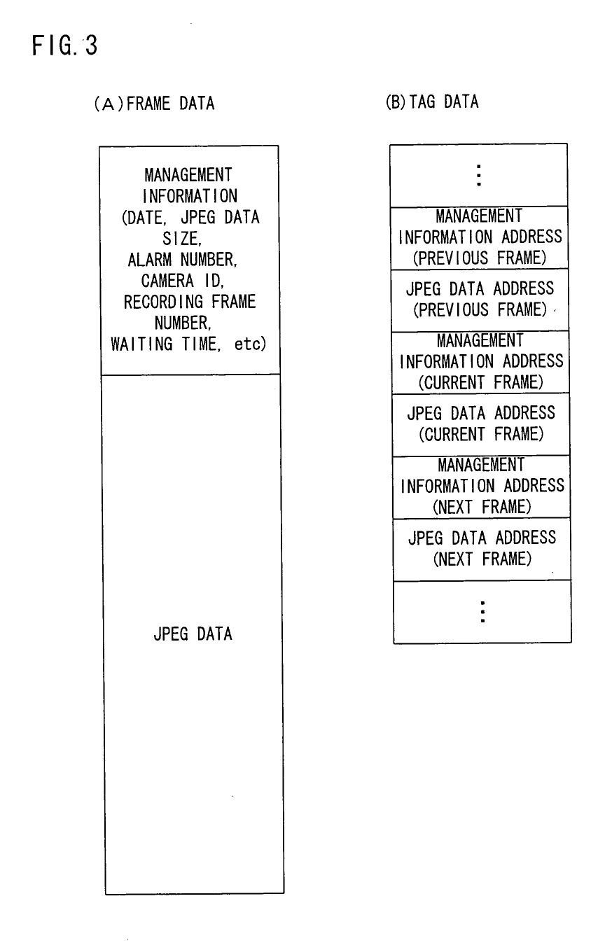

FIG. 3(A) and FIG. 3(B) show data format at a time of recording in the hard disk 20 the image data compressed in the JPEG format by the video decoder 18. As shown in FIG. 3(A), the JPEG data is recorded as frame data in the hard disk 20 together with management information. The management information includes information such as photographed date, JPEG data size, waiting time and etc.

Herein, the waiting time is a time interval at a time that the image data is intermittently recorded in the hard disk 20. For example, in a case the number of image data recorded in the hard disk 20 is 10 frames per second, the waiting time is 0.1 second. The shorter the waiting time is, the more the number of images per second is, and therefore, a high-quality image (high in refresh rate) can be obtained.

As shown in FIG. 3(B), each TAG data is constructed by a set of an address of the JPEG data and an address of the management information. When new frame of the JPEG data is added to the hard disk 20, the address of the management information is added to the TAG data together with the address of the JPEG data which is added anew. It is noted that a data amount of each TAG data is constant.

Next, with referring to FIG. 1 again, a description is made on a reproducing operation of the hard disk recorder 14. The user instructs to reproduce the image data recorded in the hard disk 20 by operating the operating buttons 26a of the hard disk recorder 14. Thereupon, the main microcomputer 24 sequentially reads JPEG data from the hard disk 20 in an order of the TAG data chronologically stored in the hard disk 20 and applies the read JPEG data to the video encoder 22 via the bus 32. The video encoder 22 expands the applied JPEG data and then converts the expanded JPEG data into an image signal through a D/A conversion. The converted image signal is reproduced on a screen of the monitor 16. At this time, the main microcomputer 24 reads the waiting time included in the management information of the frame data on the basis of the management information address of the TAG data and stores the read waiting time in the register 24a as a period (image reproducing period) lapsing before being renewed to a next image.

Next, a description is made on a case where the image reproducing period of the image is changed. In a case the image reproducing period is to be shortened, the user shortens the image reproducing period of the image by operating the jog dial 26b. The operation of shortening the image reproducing period by the user also means user's request for changing from an image currently displayed to a next image. Therefore, the hard disk recorder 14 shortens the image reproducing period of the image and, at the same time, performs a change to the next image. Furthermore, in a case the user intends to lengthen the image reproducing period of the image by operating the jog dial 26b, not only the user thinks that the image reproducing period of the image currently displayed is too short but also he or she still wants to view the image currently displayed. Thus, when the user performs the operation for lengthening the image reproducing period, the image currently displayed is not to be renewed.

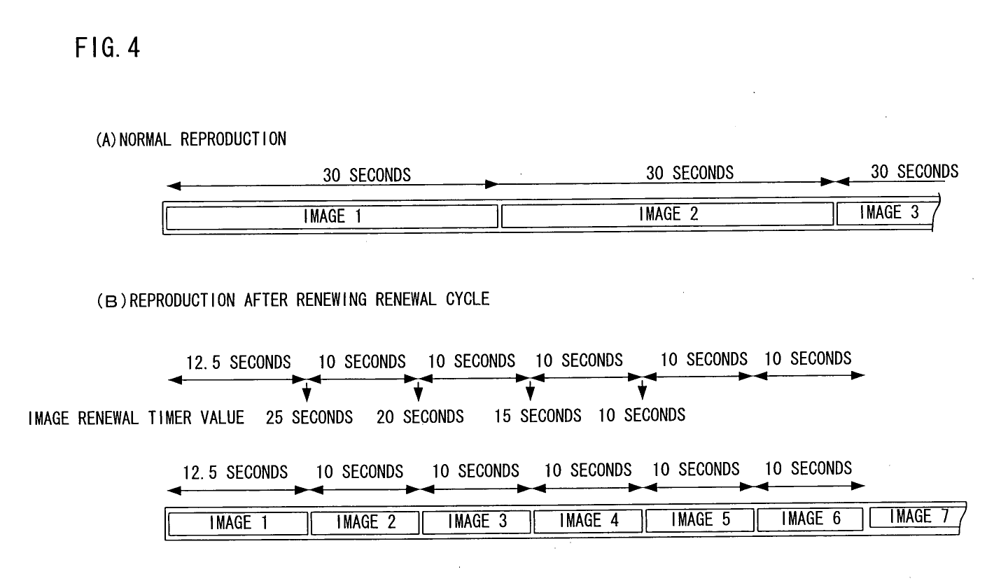

Referring to FIG. 4(A) and FIG. 4(B), a description is further made on a case where the user changes the image reproducing period of the image stored in the register 24a by utilizing the jog shuttle as the jog dial 26b so as to renew the image. As shown in FIG. 4(A), in a case the JPEG data stored in the hard disk 20 is data intermittently recorded every 30 seconds, when the hard disk recorder 14 performs a normal reproduction on the JPEG data, the image to be reproduced is changed one after another, an image 1, an image 2, an image 3 . . . every 30 seconds so as to be displayed on the monitor 16.

Herein, as shown in FIG. 4(B), a description is made on a case where the user intends to change the image reproducing period from 30 seconds to 10 seconds 12.5 seconds after the image 1 is displayed on the monitor 16. A change of shortening the image reproducing period of the image is performed by turning the jog dial 26b. One click of the jog dial 26b to the right direction shortens the image reproducing period by 5 seconds such that the image reproducing period is made to be 25 seconds, and immediately changes from the image 1 to the image 2 without waiting for a lapse of the image reproducing period set in the timer 30. At this time, the value of the register 24a is also renewed to 25 seconds.

The same is true for the following description. One click of the jog dial 26b to the right direction by the user 10 seconds after being changes to the image 2 further shortens the image reproducing period by 5 seconds such that the image reproducing period is made to be 20 seconds and, at the same time, immediately changes from the image 2 displayed on the monitor 16 to the image 3. At this time, the value of the register 24a is also changed to 20 seconds. Furthermore, one click of the jog dial 26b to the right direction 10 seconds after being changed to the image 3 further shortens the image reproducing period by 5 seconds such that the image reproducing period is made to be 15 seconds and, at the same time, immediately changes from the image 3 displayed on the monitor 16 to the image 4. At this time, the value of the register 24a is also renewed to 15 seconds. In addition, one click of the jog dial 26b to the right direction 10 seconds after being changed to the image 4 further shortens the image reproducing period by 5 seconds such that the image reproducing period is made to be 10 seconds and, at the same time, immediately changes from the image 4 displayed on the monitor 16 to the image 5. At this time, the value of the register 24a is also renewed to 10 seconds.

Through a series of operations, the image reproducing period stored in the register 24a becomes 10 seconds being a target value and therefore, even if the jog dial 26b is not clicked thereafter, the image displayed on the monitor 16 is changed every 10 seconds.

It is noted that although a description is made on a case where the image reproducing period is shortened in this embodiment, the same is true for the case where the image reproducing period is lengthened. That is, one click of the jog dial 26b to the left direction lengthens the image reproducing period by 5 seconds. Therefore, it is appropriate that the user turns the jog dial 26b to the left direction by a predetermined number of clicks until a desired image reproducing period elapses.

Furthermore, although a description is made on a case where the JPEG data is reproduced in a chronological order, i.e., in a forward direction, the JPEG data may be reproduced in a reverse direction to the forward direction, i.e., in a reverse chronological order. Whether the JPEG data is reproduced in the chronological order or in the reverse direction to the chronological order is selected by operating the operating buttons 26a by the user. The selected reproducing direction is stored in the register 24b.

In the above-described example, it is submitted that the jog dial 26b is turned to the right direction in order to shorten the image reproducing period. However, this is related to the reproducing direction and is for a case where the reproduction is made in the forward direction. On the other hand, in a case the reproducing direction is the reverse direction, a relation between a direction to which the jog dial 26b is turned and the image reproducing period is converse. That is, turning the jog dial 26b to the right direction lengthens the image reproducing period, and turning the jog dial 26b to the left direction shortens the image reproducing period.

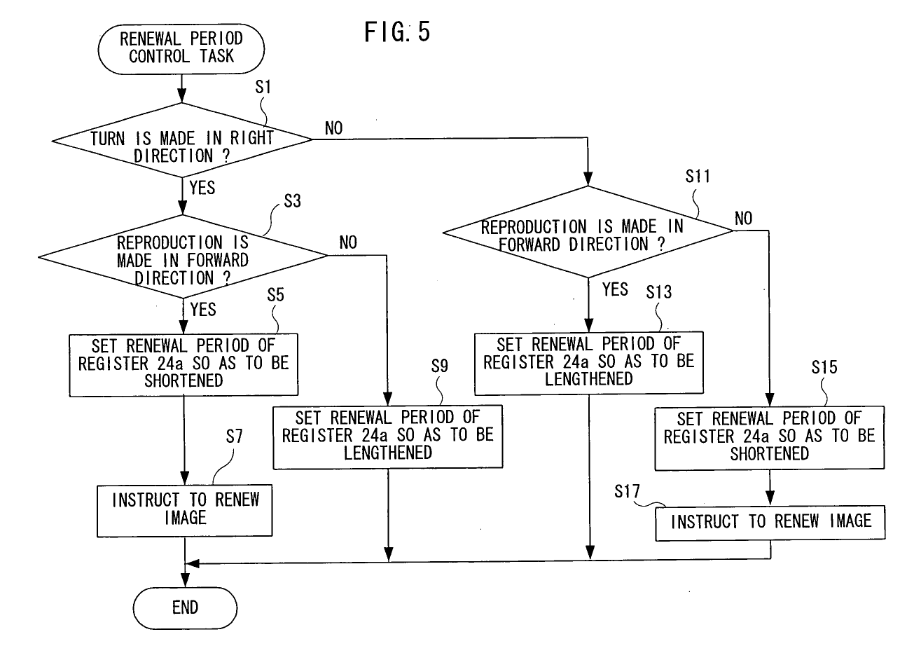

Referring to FIG. 5, a description is made on a flowchart of an image reproducing period control task of the hard disk recorder 14. In a step S1, it is determined whether the jog dial 26b is turned to the right direction or the left direction in a step S1. As a consequence thereof, if “YES” is determined, that is, if it is determined the jog dial 26b is turned to the right direction, the process proceeds to a step S3. In the step S3, it is determined whether the reproducing direction of the image is the forward direction or the reverse direction. This is performed by reading the value stored in the register 24b and determined thereby. As a consequence thereof, if “YES” is determined, that is, if the reproducing direction of the image is the forward direction, the process proceeds to a step S5. In the step S5, the image reproducing period is renewed so as to be shortened by one click of the jog dial 26b, and the renewed value is stored in the register 24a. Then, in a step S7, a renewal instruction of the image is issued to the video encoder 22 and then, an image reproducing period control task is ended. Then, a start-up of a next image reproducing period control task is waited.

On the other hand, if “NO” is determined in the step S3, that is, if the value read from the register 24b is representative of the reverse direction in the reproducing direction of the image, the process proceeds to a step S9. In the step S9, the image reproducing period is renewed so as to be lengthened by one click of the jog dial 26b, and the renewed value is stored in the register 24a and thereafter, the image reproducing period control task is ended. Then, a start-up of a next image reproducing period control task is waited.

Furthermore, if “NO” in the step S1, that is, if it is determined the jog dial 26b is turned to the left direction, the process proceeds to a step S11. In the step S11, it is determined whether the reproducing direction of the image is the forward direction or the reverses direction. This is performed by reading the value stored in the register 24b and determined thereby. As a consequence thereof, if “YES” is determined, that is, if the reproducing direction of the image is the forward direction, the process proceeds to a step S13. In the step S13, the image reproducing period is renewed so as to be lengthened by one click of the jog dial 26b, the renewed value is stored in the register 24a, and thereafter, the image reproducing period control task is ended. Then, a start-up of a next image reproducing period control task is waited.

On the other hand, if “NO” is determined in the step S11, that is, if the value read from the register 24b is representative of the reverse direction to the reproducing direction of the image, the process proceeds to a step S15. In the step S15, the image reproducing period is renewed so as to be shortened by one click of the jog dial 26b, and the renewed value is stored in the register 24a. Then, a renewal instruction of the image is issued to the video encoder 22 in a step S17 and then, the image reproducing period control task is ended. Then, a start-up of a next image reproducing period control task is waited.

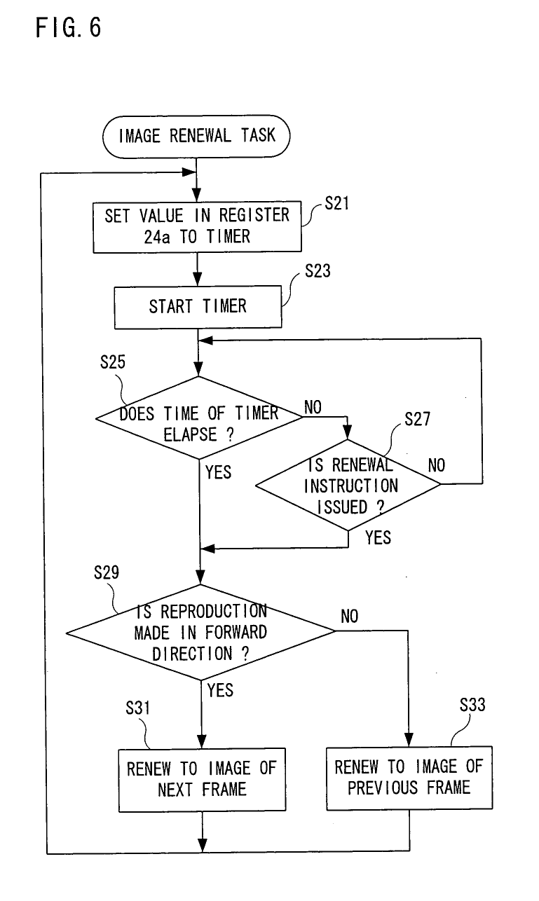

Next, with referring to FIG. 6, a description is made on a flowchart of an image renewal task of the hard disk recorder 14. When the value stored in the register 24a is set to the timer 30 in a step S21 and then, the timer 30 is started in a step S23, the count value of the timer 30 is decremented. It is determined whether or not the time of the timer 30 elapses in a step S25. Herein, a lapse of the time of the timer 30 means that the count value of the timer 30 is decremented from the value stored in the register 24a to “0”. As a consequence of the determination in the step S25, if “NO” is determined, the time of the timer 30 does not elapse, and therefore, the process proceeds to a step S27. In the step S27, it is determined whether or not the renewal instruction of the image described in the step S7 or the step S17 in FIG. 5 is issued to the video encoder 22. If “NO” is determined, that is, if the renewal instruction of the image is not issued, the process returns to the step S25. The process is repeated until the time of the timer 30 elapses.

If “YES” is determined in the step S25, that is, if the time of the timer 30 elapses, or if “YES” is determined in the step S27, that is, if the renewal instruction of the image is issued, the process proceeds to a step S29. In the step S29, it is determined whether the reproducing direction of the image is the forward direction or the reverse direction. This is performed by reading the value stored in the register 24b and determined thereby. As a consequent thereof, if “YES” is determined, that is, if the reproducing direction of the image is the forward direction, the process proceeds to a step S31 so as to instruct the video encoder 22 to process an image of a next frame and output the same on the monitor 16, and then, the process returns to the step S21. On the other hand, if “NO” is determined in the step S29, that is, if the reproducing direction of the image is the reverse direction, the process proceeds to a step S33 so as to instruct the video encoder 22 to process an image of a previous frame and output the same on the monitor 16, and then, the process returns to the step S21.

It is noted that although a description is made on the input image of the hard disk recorder 14 by taking the image from the surveillance camera 12 as an example, it is not limited thereto. Furthermore, it is needless to say that an optical disk or a semiconductor memory may be adapted as a recording medium in stead of the hard disk 20.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing apparatus which sequentially reproduces a plurality of screens of still image signals recorded in a recording medium, comprising:
a timer for measuring an image reproducing period;
a first reproducer for reproducing one screen of still image signal from said recording medium every time that a time of said timer elapses;
a second reproducer for reproducing one screen of still image signal from said recording medium every time that an image renewal instruction is issued;
a restarter for restarting said timer every time that said one screen of still image signal is reproduced;
a changer for changing the image reproducing period in response to a period changing instruction; and
an issuer for issuing the image renewal instruction in response to the period changing instruction.

2. An image processing apparatus according to claim 1, wherein said issuer stops issuing the image renewal instruction when the period changing instruction is for extending the image reproducing period.

3. An image processing apparatus according to claim 2, further comprising a dial for inputting the changing instruction, wherein said issuer stops issuing the image renewal instruction when a reproducing direction of said plurality of screens of the still image signals is a first reproducing direction and a rotating direction of said dial is a first rotating direction, or when a reproducing direction of said plurality of screens of the still image signals is a second reproducing direction and the rotating direction of said dial is a second rotating direction.

4. An image processing apparatus according to claim 3, wherein the first reproducing direction is a forward reproducing direction, the second reproducing direction is a reverse reproducing direction, the first rotating direction is a counterclockwise direction, and the second rotating direction is a clockwise direction.

5. An image processing apparatus according to any one of claims 1 to 4, further comprising a recorder for recording said plurality of screens of the still image signals in said recording medium.

6. An image processing apparatus which sequentially reproduces a plurality of screens of still image signals recorded in a recording medium, comprising steps of:
(a) reproducing one screen of still image signal from said recording medium every time that a time of a timer for measuring an image reproducing period elapses;
(b) reproducing one screen of still image signal from said recording medium every time that an image renewal instruction is issued;
(c) restarting said timer every time that said one screen of still image signal is reproduced;
(d) changing the image reproducing period in response to a period changing instruction; and
(d) issuing the image renewal instruction in response to the period changing instruction.
